(19) United States
(12) Patent Application Publication
(10) Pub. No.: US 2025/0229843 A1
(43) Pub. Date: Jul. 17, 2025

(54) VEHICLE BODY REAR STRUCTURE

(71) Applicant: Honda Motor Co., Ltd., Tokyo (JP)

(72) Inventor: Kanji FUJII, Tokyo (JP)

(73) Assignee: Honda Motor Co., Ltd., Tokyo (JP)

(21) Appl. No.: 19/006,264

(22) Filed: Dec. 31, 2024

(30) Foreign Application Priority Data
Jan. 16, 2024 (CN) 202410059248.9

(51) Int. Cl. B62D 25/20; B62D 25/18

(52) U.S. Cl. CPC B62D 25/2036; B62D 25/18; B62D 25/2027

(57) ABSTRACT

The invention provides a vehicle body rear structure having good rigidity. The vehicle body rear structure includes: a rear member made of aluminum; and a side panel assembly made of iron. The rear member includes: a rear interior member extended upward from a wheel cover; a tailgate ring connected to the rear interior member from a rear of the vehicle body and forming a vehicle body rear opening; and a rear side panel located at an outside of the rear interior member in a vehicle width direction, and forming a first closed cross section with the wheel cover, the rear interior member, and the tailgate ring. The side panel assembly includes: a side panel exterior member disposed at an outside of the vehicle width direction; and a rear pillar located at an inside of the side panel exterior member in the vehicle width direction and having a second closed cross section extended in a vehicle height direction along a rear side of the rear vehicle door opening. A portion of the rear pillar is overlapped with an outer surface of the rear side panel in the vehicle width direction and bonded thereto using a bonding agent.

### CROSS-REFERENCE TO RELATED APPLICATION

This application claims the priority benefit of China application serial no. 202410059248.9 filed on Jan. 16, 2024. The entirety of the above-mentioned patent application is hereby incorporated by reference herein and made a part of this specification.

### BACKGROUND OF THE INVENTION

### Field of the Invention

The invention relates to a vehicle body rear structure.

### Description of Related Art

In recent years, efforts to provide access to sustainable transportation systems that also take into account vulnerable persons such as the elderly, disabled, and children among traffic participants are growing. In order to achieve the above object, research and development to further improve the safety or convenience of transportation through development related to vehicle body rigidity are carried out. Generally, the way the metal side panels that make up the vehicle design surface and the frame members of the vehicle body structure are bonded directly affects the vehicle body rigidity. Therefore, in the prior art, various vehicle body rear structures are developed for the bonding methods of side panels and frame members of the vehicle body rear.

For example, Prior Art Document 1 discloses a vehicle body structure in which the front end or the rear end of a vehicle is integrated into a separate structure formed by a single aluminum casting. However, in the case of Prior Art Document 1, when the metal side panels forming the vehicle design surface are bonded to the integral aluminum casting, in order to prevent electrolytic corrosion at the joint between iron and aluminum, relevant processes need to be performed at each joint, requiring more processes than simply welding iron to iron. Moreover, Prior Art Document 2 discloses a vehicle body structure that ensures rigidity while reducing vehicle weight adopting resin to reduce weight, and the vehicle body rigidity is increased by bonding the bulkhead, rear pillars, frame members extended in the front and rear directions of the vehicle and side panels. However, in the case of Prior Art Document 2, when the side panels are made of resin, it is difficult to make an entire side panel formed by a single plate material and the side panel needs to be divided, thus leading to the occurrence of joint issues between the divided members, and as a result, there is also an unsightly issue for the appearance design. Furthermore, even if the entire side panel is formed by a single resin plate, since the single resin plate has no rigidity, bending or breaking may occur due to the fragility of the plate, or positioning may be difficult. Therefore, there is room for improvement in the way the side panels and frame members of the vehicle body rear are joined.

In order to solve the issue, the present application aims to improve the vehicle body rigidity, and, in turn, contribute to the development of sustainable delivery systems.

### PRIOR ART LITERATURE

### Patent Literature

[Patent Document 1] Japanese Patent Publication No. 2023-053749
[Patent Document 2] Japanese Patent Publication No. 6900900

### SUMMARY OF THE INVENTION

The invention provides a vehicle body rear structure having good rigidity.

The invention provides a vehicle body rear structure. The vehicle body rear structure includes: a rear member made of aluminum; and a side panel assembly made of iron. The rear member includes: a rear interior member extended upward from a wheel cover; a tailgate ring connected to the rear interior member from a rear of a vehicle body and forming a vehicle body rear opening; and a rear side panel located at an outside of the rear interior member in a vehicle width direction and forming a first closed cross section with the wheel cover, the rear interior member, and the tailgate ring. The side panel assembly includes: a side panel exterior member disposed at an outside of the vehicle width direction; and a rear pillar located at an inside of the side panel exterior member in the vehicle width direction and having a second closed cross section extended in a vehicle height direction along a rear side of the rear vehicle door opening. A portion of the rear pillar is overlapped with an outer surface of the rear side panel in the vehicle width direction and bonded thereto using a bonding agent.

In an embodiment of the invention, the rear member further includes a rear groove located at the outside of the tailgate ring, the rear groove is disposed to cover an upper end of the rear side panel from above, and a first water-stopping structure is disposed between the rear groove and the side panel exterior member.

In an embodiment of the invention, the side panel exterior member of the side panel assembly has no fastening point at a wheel cover arch of the rear side panel.

Based on the above, in the vehicle body rear structure of an embodiment of the invention, at the inside of the overlap region of a portion of the rear pillar and the rear side panel, the first closed cross section is formed by making the rear side panel cover the rear interior member as the vehicle body frame member, the tailgate ring, and the wheel cover from the outside, thus improving vehicle body rigidity and reducing the number of fastening points needed between the side panel exterior member and the rear member. Furthermore, by disposing the rear pillar having the second closed cross section on the side panel exterior member, the rigidity of the side panel assembly may be ensured. In addition, by overlapping the first closed cross section and the second closed cross section, the rigidity in the shearing direction may also be improved.

In order to make the above features and advantages of the invention better understood, embodiments are specifically provided below with reference to figures for detailed description as follows.

### BRIEF DESCRIPTION OF THE DRAWINGS

FIG. 1 is a schematic diagram of the appearance of a vehicle body rear structure according to an embodiment of the invention.

FIG. 2 is an exploded schematic view of the vehicle body rear structure shown in FIG. 1.

FIG. 3 is an exploded schematic view of the rear member shown in FIG. 2.

FIG. 4 is an exploded schematic view of the side panel assembly shown in FIG. 2.

FIG. 5A is a schematic side view of the vehicle body rear structure shown in FIG. 3.

FIG. 5B is a schematic side view of the vehicle body rear structure shown in FIG. 5A with the side panel exterior member removed.

FIG. 5C is a schematic three-dimensional view of the vehicle body rear structure shown in FIG. 5A with the side panel exterior member removed.

FIG. 6 is a schematic cross-sectional view of the vehicle body rear structure shown in FIG. 5A along section line A-A.

FIG. 7 is a schematic cross-sectional view of the vehicle body rear structure shown in FIG. 5A along section line B1-B1.

FIG. 8 is a schematic cross-sectional view of the vehicle body rear structure shown in FIG. 5A along section line B2-B2.

FIG. 9A is a schematic structural diagram of a comparative example according to the prior art.

FIG. 9B is an enlarged schematic view of the vehicle body rear structure shown in FIG. 8 at the wheel cover arch.

### DESCRIPTION OF THE EMBODIMENTS

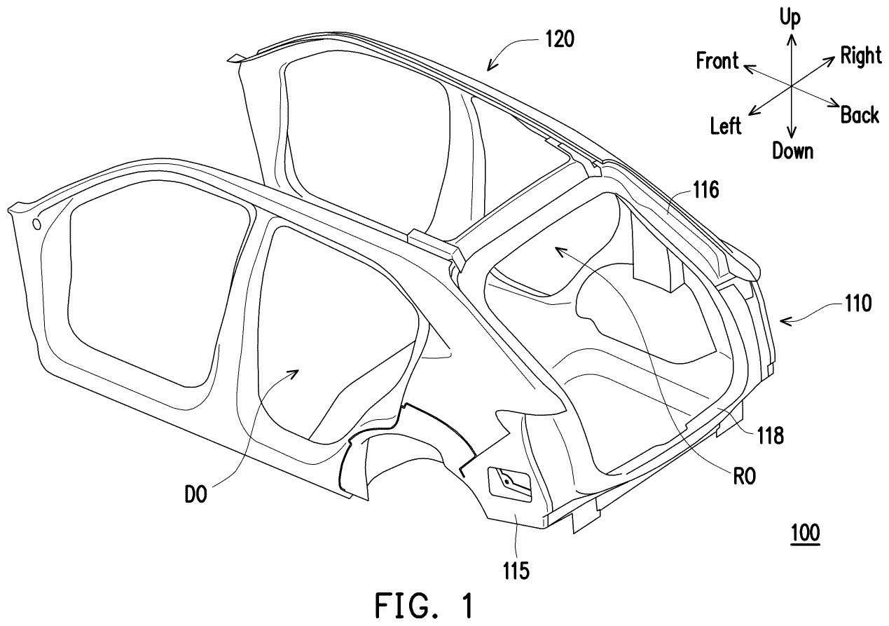

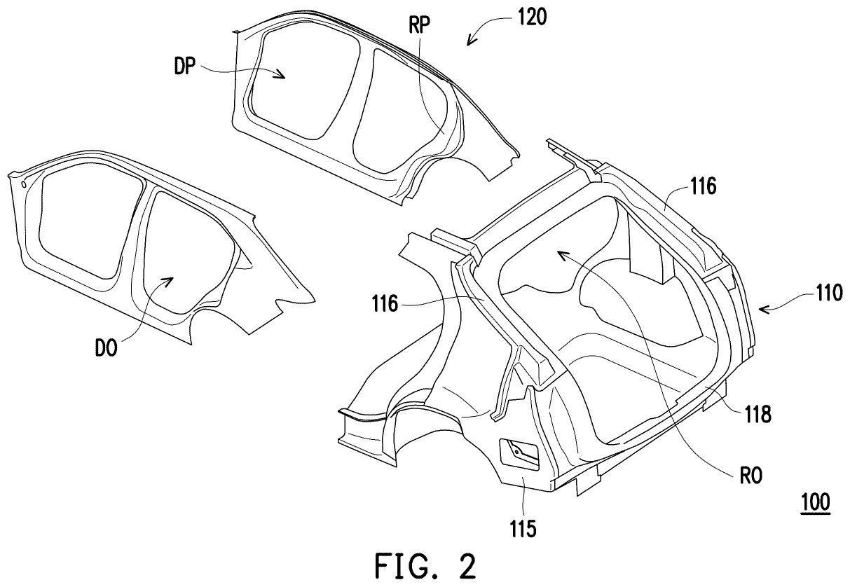

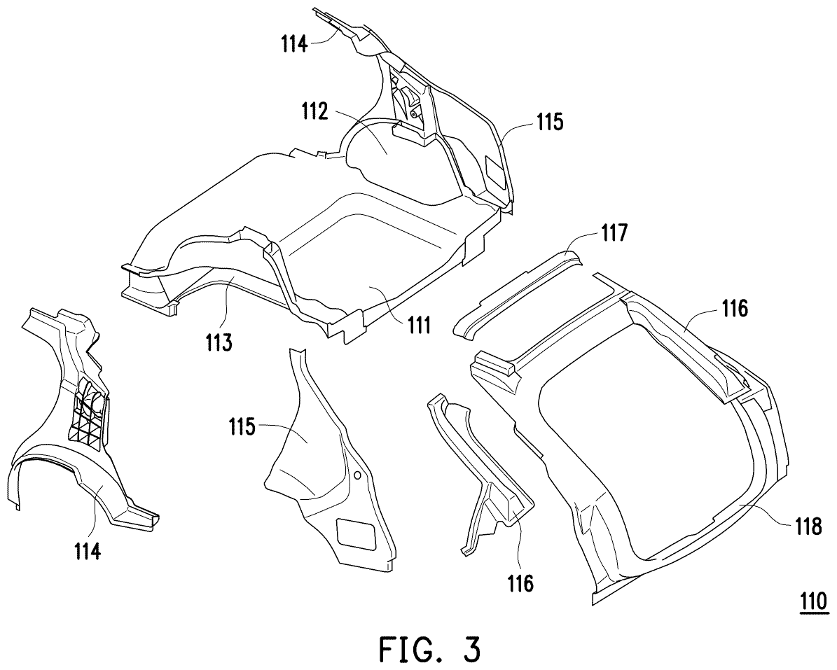

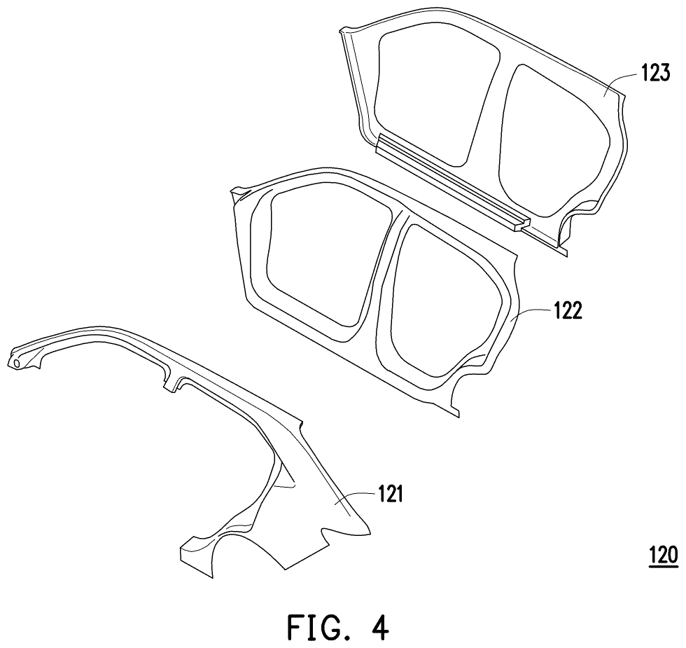

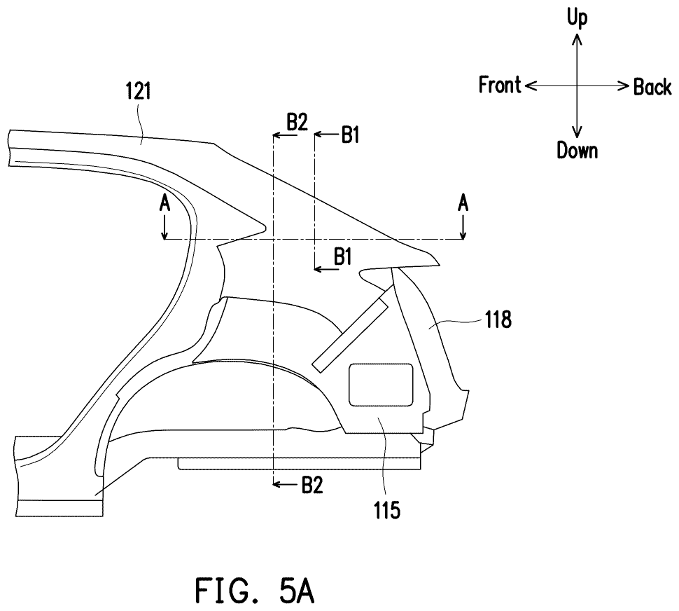

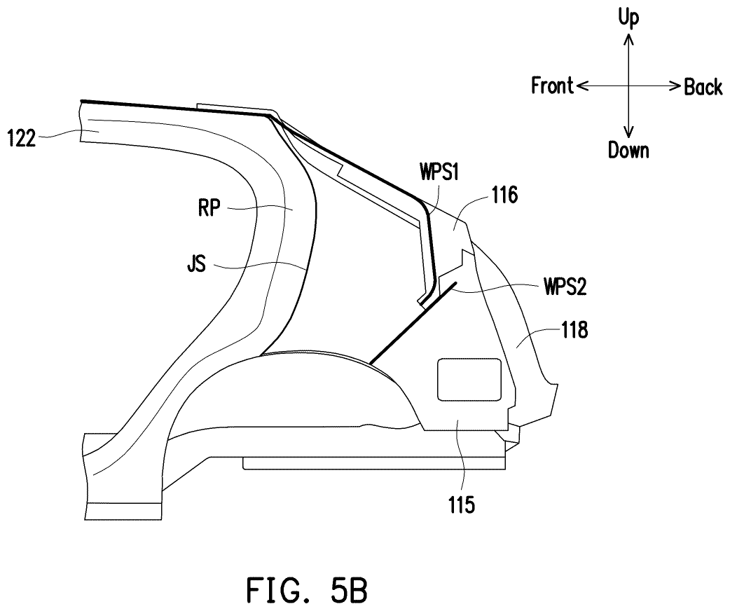

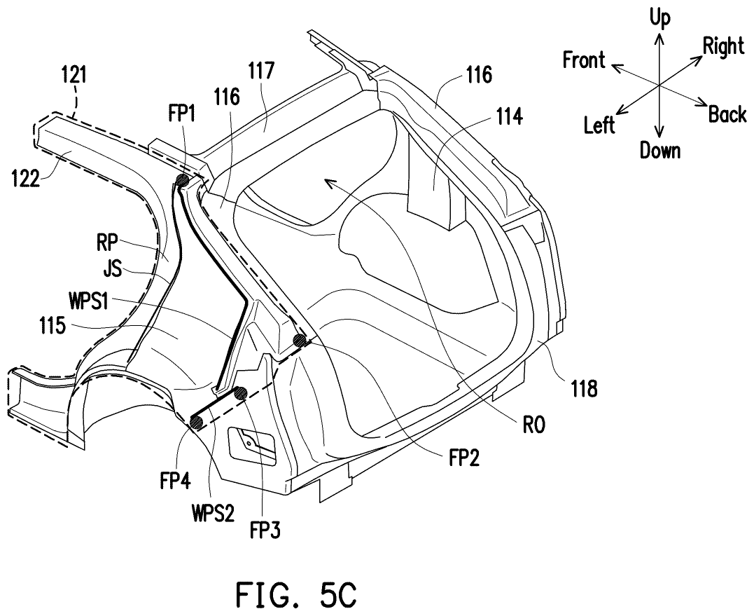

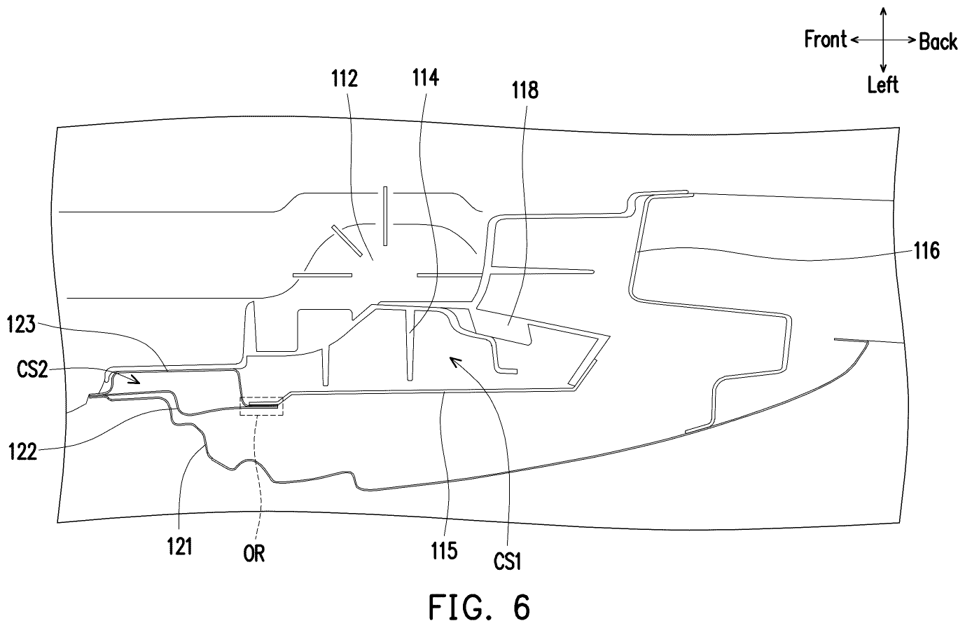

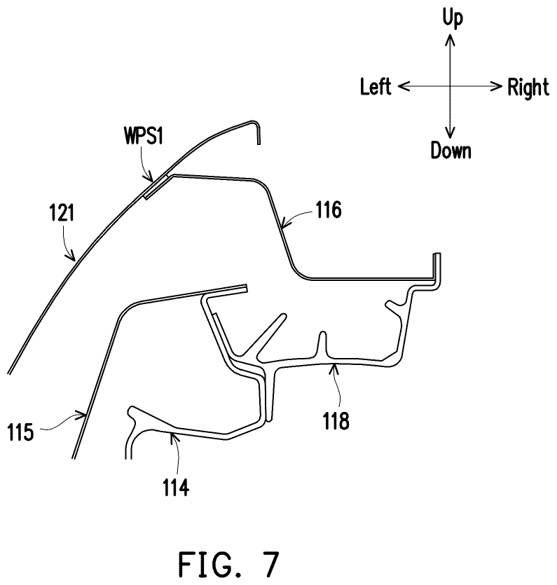

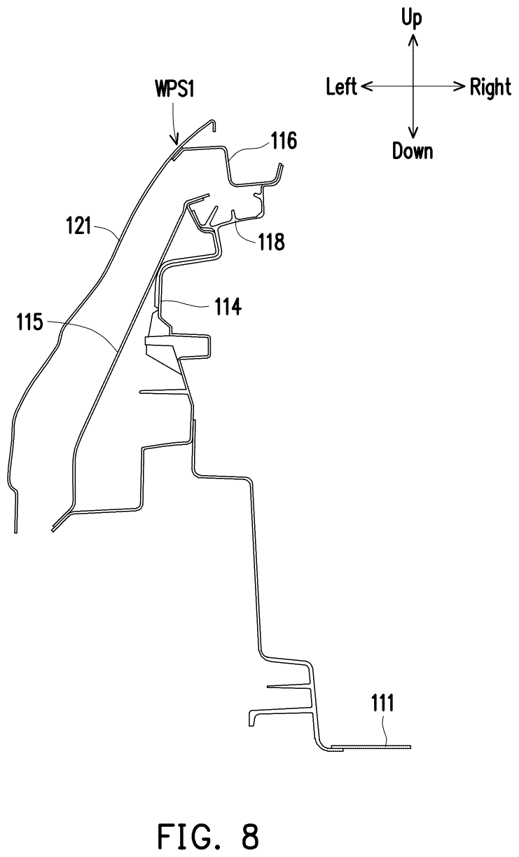

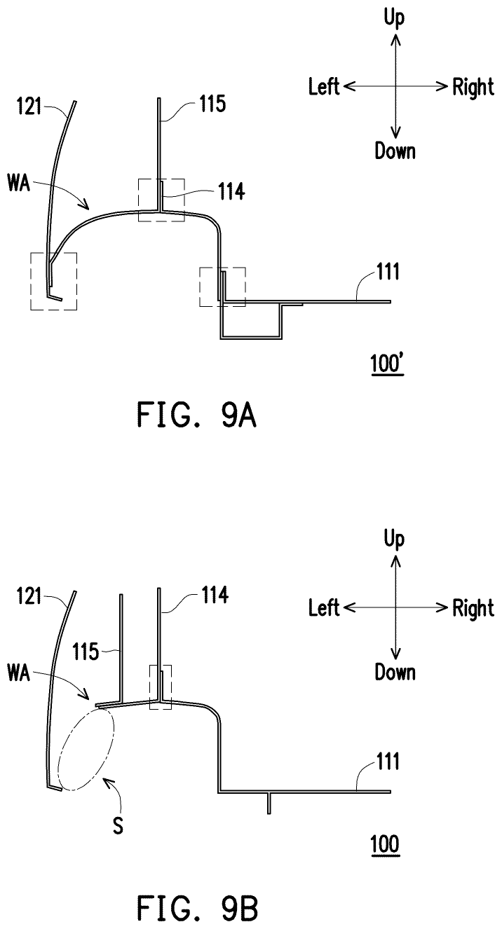

FIG. 1 is a schematic diagram of the appearance of a vehicle body rear structure according to an embodiment of the invention. FIG. 2 is an exploded schematic view of the vehicle body rear structure shown in FIG. 1. FIG. 3 is an exploded schematic view of the rear member shown in FIG. 2. FIG. 4 is an exploded schematic view of the side panel assembly shown in FIG. 2. FIG. 5A is a schematic side view of the vehicle body rear structure shown in FIG. 3. FIG. 5B is a schematic side view of the vehicle body rear structure shown in FIG. 5A with the side panel exterior member removed. FIG. 5C is a schematic three-dimensional view of the vehicle body rear structure shown in FIG. 5A with the side panel exterior member removed. FIG. 6 is a schematic cross-sectional view of the vehicle body rear structure shown in FIG. 5A along section line A-A. FIG. 7 is a schematic cross-sectional view of the vehicle body rear structure shown in FIG. 5A along section line B1-B1. FIG. 8 is a schematic cross-sectional view of the vehicle body rear structure shown in FIG. 5A along section line B2-B2. FIG. 9A is a schematic structural diagram of a comparative example according to the prior art. FIG. 9B is an enlarged schematic view of the vehicle body rear structure shown in FIG. 8 at the wheel cover arch. It should be noted that, for the sake of convenience below, the front-rear direction, the left-right direction, and the up-down direction of the vehicle are defined as shown in the figures, and the configuration of each portion is explained based on the definitions. The front and rear directions, the left and right directions, and the up and down directions are respectively equivalent to the vehicle length direction, the vehicle width direction, and the vehicle height direction. In the present embodiment, a vehicle body rear structure 100 refers to the partial structure near a rear member 110 and a side panel assembly 120 in a vehicle. The specific structure of the vehicle body rear structure 100 is described below with reference to FIG. 1 to FIG. 9B.

Please refer to FIG. 1 to FIG. 8. In the present embodiment, the vehicle body rear structure 100 includes a rear member 110 made of aluminum and a side plate assembly 120 made of iron. Specifically, as shown in FIG. 1 to FIG. 3, in the present embodiment, the rear member 110 includes a rear floor 111 disposed at the bottom, a wheel cover 112 disposed at both left and right sides, a rear side frame 113, a rear interior member 114, a rear side panel 115, and a rear groove 116, and a roof beam 117 and a tailgate ring 118 disposed at the rear, wherein the rear interior member 114 is an aluminum casting having high rigidity, and the roof beam 117, the rear groove 116, the tailgate ring 118, and the rear side panel 115 are all plate structures made of aluminum. More specifically, as shown in FIG. 3, the rear floor 111 is connected to a pair of left and right rear side frames 113 at the bottom of the vehicle body rear structure 100. The rear side frames 113 are extended along the vehicle length direction at the outside of the rear floor 111 in the vehicle width direction. The wheel cover 112 is disposed at the outside of the rear side frames 113 in the vehicle width direction and connected to the rear side frames 113. In addition, the wheel cover 112 and the rear side frames 113 may also be formed by an integral aluminum casting. Furthermore, as shown in FIG. 3, the rear interior member 114 is extended upwardly from the wheel cover 112, the tailgate ring 118 is connected to the rear interior member 114 from the rear of the vehicle body rear structure 100 and forms a vehicle body rear opening RO, the rear side panel 115 is located at the outside of the rear interior member 114 in the vehicle width direction, the rear groove 116 is located at the outside of the tailgate ring 118, and the rear groove 116 is disposed to cover the upper end of the rear side panel 115 from above. Furthermore, as shown in FIG. 3, FIG. 5A, FIG. 5B, and FIG. 6, the rear side panel 115, the rear interior member 114, the tailgate ring 118 and the wheel cover 112 form a first closed cross section CS1.

Moreover, as shown in FIG. 4, in the present embodiment, the side panel assembly 120 includes a side panel exterior member 121, a door ring inner member 123, and a door ring outer member 122, wherein the side panel exterior member 121 is disposed at the outside of the vehicle width direction, and the door ring inner member 123 and the door ring outer member 122 are bonded at the inside of the side panel exterior member 121 in the vehicle width direction to form a door pillar DP. More specifically, as shown in FIG. 4, the rear of the door ring inner member 123 and the rear of the door ring outer member 122 may form a rear pillar RP connected to the rear side panel 115 of the rear member 110. Furthermore, as shown in FIG. 4, FIG. 5A, FIG. 5B, and FIG. 6, the rear pillar RP is located at the inside of the side panel exterior member 121 in the vehicle width direction and has a second closed cross section CS2 extended in the vehicle height direction along the rear side of the rear vehicle door opening DO. Furthermore, a portion of the rear pillar RP formed by the door ring outer member 122 is extended rearward and overlapped with the outer surface of the rear side panel 115 in the vehicle width direction, and a portion of the rear pillar RP and an overlap region OR of the rear side panel 115 may be bonded using a bonding agent to form a sealing layer as a bonding structure JS.

In this way, at the inside of the overlap region OR of a portion of the rear pillar RP and the rear side panel 115, the first closed cross section CS1 is formed by making the rear side panel 115 cover the rear interior member 114 as a vehicle body frame member, the tailgate ring 118, and the wheel cover 112 from the outside, thus improving vehicle body rigidity and reducing the number of fastening points needed between the side panel exterior member 121 and the rear member 110. Furthermore, by disposing the rear pillar RP having the second closed cross section CS2 on the side panel exterior member 121, the rigidity of the side panel assembly 120 may be ensured. In addition, by overlapping the first closed cross section CS1 and the second closed cross section CS2, the rigidity in the shearing direction may also be improved.

Further, in the present embodiment, as shown in FIG. 5A, FIG. 5B, and FIG. 7, the rear groove 116 forms a portion of the rear member 110 made of aluminum and may be used to guide water droplets, and the rear member 110 is provided with a sealing layer as a first water-stopping structure WPS1 between the rear groove 116 and the side panel exterior member 121, and a sealing layer as a second water-stopping structure WPS2 is disposed between the rear side panel 115 and the side panel exterior member 121 to form a water-tight structure to prevent water droplets from penetrating. In this way, via the configuration design of the rear groove 116, the sealing layer of the bonding structure JS, and the sealing layer as the first water-stopping structure WPS1, the need for the number of fastening points may be further reduced. More specifically, as shown in FIG. 5C, in the present embodiment, the fastening points of the side panel exterior member 121 and the rear member 110 of the side panel assembly 120 are respectively only formed by a first fastening point FP1 where the roof beam 117, the rear pillar RP, and the rear groove 116 are connected, a second fastening point FP2 where the rear groove 116 and the tailgate ring 118 are connected, and a third fastening point FP3 and a fourth fastening point FP4 at the lower rear side of the rear side panel 115, and as shown in FIG. 8, the side panel exterior member 121 of the side panel assembly 120 does not have a fastening point at the wheel cover arch WA of the rear side panel 115.

In this way, by having the rear groove 116 form a portion of the rear member 110 made of aluminum, compared to the case in which the rear groove 116 is disposed at the side panel assembly 120, the number of fastening points of the side plate assembly 120 and the rear member 110 may be reduced, thereby reducing the number of processes for preventing electrolytic corrosion. Moreover, in the present embodiment, a treatment process to prevent electrolytic corrosion may be performed at each fastening point before assembling the side panel exterior member 121 and the rear member 110, thereby simplifying the process. Moreover, in the present embodiment, by disposing the first water stop structure WPS1 in the rear groove 116, the shape of the vehicle body appearance may be changed to match the structure of the side panel assembly 120. In this way, the degree of freedom in design may be increased and the rear side panel 115 may be prevented from being enlarged.

In addition, since the side panel exterior member 121 of the side panel assembly 120 has no fastening points at the wheel cover arch WA of the rear side panel 115, compared with the case in which fastening points need to be disposed in the prior art, the vehicle body rear structure 100 is not affected by bonding errors, making it easier to control the accuracy of the vehicle body rear structure 100 in the vehicle width direction. For example, as shown in FIG. 9A, in the case of a vehicle body rear structure 100′ of the prior art, there are three fastening points at the bottom of the vehicle body rear structure 100′ in the vehicle width direction that are respectively the joint of the side panel exterior member 121 and the rear side panel 115 of the prior art near the wheel cover arch WA of the rear side panel 115, the joint of the rear side panel 115 and the rear interior member 114, and the joint of the rear interior member 114 and the rear floor 111, and when there is a tolerance in the vehicle height direction and the vehicle width direction at the joint, deviation may occur at each single fastening point respectively. When there are three fastening points, there may be greater deviations at both the left and right sides of the vehicle width direction. On the other hand, as shown in FIG. 9B, in the present embodiment, since there is no fastening point between the side panel exterior member 121 of the vehicle body rear structure 100 and the wheel cover arch WA of the rear side panel 115, there is no need for bonding and there is a space S. In this way, even if a bonding error occurs in the rear member 110 of the vehicle body rear structure 100, the space S between the side panel exterior member 121 and the wheel cover arch WA of the rear side panel 115 may still be controlled to prevent the vehicle body rear structure 100 from being affected by bonding errors, thereby making it easier to control the accuracy of the vehicle body rear structure 100 in the vehicle width direction.

Based on the above, in the vehicle body rear structure of an embodiment of the invention, at the inside of the overlap region of a portion of the rear pillar and the rear side panel, the first closed cross section is formed by making the rear side panel cover the rear interior member as the vehicle body frame member, the tailgate ring, and the wheel cover from the outside, thus improving vehicle body rigidity and reducing the number of fastening points needed between the side panel exterior member and the rear member. Furthermore, by disposing the rear pillar having the second closed cross section on the side panel exterior member, the rigidity of the side panel assembly may be ensured. In addition, by overlapping the first closed cross section and the second closed cross section, the rigidity in the shearing direction may also be improved.

Lastly, it should be noted that the above embodiments are used to describe the technical solution of the invention instead of limiting it. Although the invention has been described in detail with reference to each embodiment above, those having ordinary skill in the art should understand that the technical solution recited in each embodiment above may still be modified, or some or all of the technical features thereof may be equivalently replaced. These modifications or replacements do not make the essence of the corresponding technical solutions depart from the scope of the technical solution of each embodiment of the invention.

What is claimed is:

1. A vehicle body rear structure, comprising:
a rear member made of aluminum; and
a side plate assembly made of iron,
the rear member comprising:
a rear interior member extended upward from a wheel cover;
a tailgate ring connected from a rear of a vehicle body to the rear interior member and forming a vehicle body rear opening; and
a rear side panel located at an outside of the rear interior member in a vehicle width direction and forming a first closed cross section with the wheel cover, the rear interior member, and the tailgate ring;
the side panel assembly comprises:
a side panel exterior member disposed at an outside of the vehicle width direction; and
a rear pillar located at an inside of the side panel exterior member in the vehicle width direction and having a second closed cross section extended in a vehicle height direction along a rear side of a rear vehicle door opening, and
a portion of the rear pillar is overlapped with an outer surface of the rear side panel in the vehicle width direction and bonded thereto using a bonding agent.

2. The vehicle body rear structure of claim 1, wherein,
the rear member also comprises a rear groove located at an outside of the tailgate ring,
the rear groove is disposed to cover an upper end of the rear side panel from above,
a first water-stopping structure disposed between the rear groove and the side panel exterior member.

3. The vehicle body rear structure of claim 1, wherein.
the side panel exterior member has no fastening point at a wheel cover arch of the rear side panel.
